(19) United States
(12) Patent Application Publication
(10) Pub. No.: US 2025/0042485 A1
(43) Pub. Date: Feb. 6, 2025

(54) AIR-GUIDING ELEMENT AND MOTOR VEHICLE COMPRISING AN AIR-GUIDING ELEMENT

(71) Applicant: Dr. Ing. h.c. F. Porsche Aktiengesellschaft, Stuttgart (DE)

(72) Inventors: Dominik Beierl, Korntal-Münchingen (DE); Bernd Herrmann, Ehningen (DE); Joachim Paul, Benningen a.N. (DE); Okan Gönüldinc, Ostfildern (DE); Moritz Zeh, Stuttgart (DE)

(73) Assignee: Dr. Ing. h.c. F. Porsche Aktiengesellschaft, Stuttgart (DE)

(21) Appl. No.: 18/760,118

(22) Filed: Jul. 1, 2024

(30) Foreign Application Priority Data
Aug. 1, 2023 (DE) 102023120399.1

(51) Int. Cl. B62D 35/00

(52) U.S. Cl. CPC B62D 35/007

(57) ABSTRACT

An air guiding element with a surface element and a longitudinally displaceable carrier element. The surface element is articulated to the carrier element in a movably mounted manner, furthermore with a drive element with a gearwheel. The carrier element can be driven in a longitudinally displaceable manner by the gearwheel transmission in such a way that a rack of the gearwheel transmission is connected to the drive element in a drivable manner via a spur gear and the rack is in driving connection with the carrier element.

### CROSS-REFERENCE TO RELATED APPLICATION

This application claims priority to German Patent Application No. 10 2023 120 399.1, filed Aug. 1, 2023, the content of such application being incorporated by reference herein in its entirety.

### FIELD OF THE INVENTION

The invention relates to an air-guiding element and a motor vehicle comprising an air-guiding element.

### BACKGROUND OF THE INVENTION

In motor vehicles, it is known that an air flow flows around the motor vehicle from front to rear as the motor vehicle is traveling in the forward direction. This air flow leads to a lateral flow around the motor vehicle and a flow around the rear of the motor vehicle. At the rear, a so-called wake of the flow around the vehicle occurs, i.e. an outflow, which increases the air resistance of the motor vehicle.

To affect the lateral flow around the motor vehicle at the vehicle rear, DE 10 2015 121 785 A1, which is incorporated by reference herein, made known air-guiding elements which are configured laterally on the vehicle rear such that they can be deployed in a linearly displaceable manner, so that they project laterally and lengthen the vehicle rear to affect the air flow in order to reduce air resistance. The air-guiding elements are thus deployed from the vehicle rear in the deployment direction and accordingly placed in the air flow. This limits the effect on the air flow to the positioning of the air-guiding element as it results from the linear deployment movement, which means an undesirable restriction of the reduction in air resistance.

### SUMMARY OF THE INVENTION

Described herein is an air-guiding element and a motor vehicle comprising an air-guiding element that enables improved reduction of air resistance resulting from a lateral flow.

One example embodiment of the invention relates to an air guiding element with a surface element and a longitudinally displaceable carrier element, wherein the surface element is hinged to the carrier element in a movable manner, furthermore with a drive element with a gearwheel transmission, wherein the carrier element can be driven in a longitudinally displaceable manner by means of the gearwheel transmission in such a way that a rack of the gearwheel transmission is connected to the drive element in a drivable manner via a spur gear and the rack is in drive connection with the carrier element. The carrier element can thus be safely and reliably displaceably disposed in a small installation space, wherein the surface element can be moved with the carrier element and can be moved into the air flow as needed.

It is particularly advantageous if the carrier element is mounted in a longitudinally displaceable manner in a side part or rear part of a motor vehicle, in particular a motor vehicle rear. This makes it possible to affect the flow around the motor vehicle at the rear by disposing the air-guiding element adjustably laterally on the vehicle rear; in particular by disposing two such air-guiding elements laterally on the vehicle rear.

It is also expedient if the surface element is disposed such that it can be moved through an opening of the side part or the rear part. This protects the inner region of the vehicle rear against dirt and water, etc. and the air-guiding element can still be disposed such that it can be deployed to affect the flow, while the carrier element and the drive element can be disposed such that they are protected.

It is also advantageous if the surface element is arranged so that it can be displaced relative to the carrier element by means of at least one slide track. This means that the surface element can not only be arranged to be longitudinally displaceable, but can also be laterally displaced or pivoted relative to a longitudinal movement. The longitudinally displaceable path of the carrier element and thus also of the surface element, for example, is not necessarily designed as a straight line, but can also be provided as a curved path, for example an arc-shaped path. A deviation intended for the longitudinal displacement of the surface element can be carried out by means of the slide track, for example in order to be able to angle or tilt at the end of the longitudinal displacement.

It is also expedient if the carrier element has at least one slide track, wherein at least one sliding block is arranged connected to the surface element, the at least one sliding block is arranged displaceably in the at least one slide track. By guiding the at least one sliding block in the at least one sliding track, the surface element can be pivoted or tilted.

It is also useful if the surface element can be displaced or pivoted relative to the opening when the at least one sliding block is displaced in the slide track. This is particularly advantageous if the surface element is guided through a fixed opening and can be pivoted at or through it. This allows tilting and displacement relative to the longitudinal displacement to achieve a more suitable arrangement in the airflow, to achieve improved airflow control and improved drag reduction.

One example embodiment of the invention relates to a motor vehicle comprising at least one air-guiding element, in particular comprising two air-guiding elements, according to aspects of the invention.

It is also expedient if the air-guiding elements are disposed in the rear region of the motor vehicle on a side part or rear part on two oppositely disposed sides. The flow around the rear region can thus be affected on both sides of the motor vehicle in order to improve the air resistance.

It is particularly advantageous if the at least one air-guiding element is longitudinally displaceable along a straight, angled, curved or arcuate path. This enables the available installation space to be well utilized for the positioning and displacement of the carrier element and the surface element.

It is also expedient if the carrier element and the drive element with the spindle mechanism are disposed in the side part or in the rear part and the surface element can be moved through an opening of the side part or the rear part.

### BRIEF DESCRIPTION OF THE DRAWINGS

The invention is described in detail in the following on the basis of an example embodiment with reference to the drawings.

FIG. 1 depicts a schematic perspective illustration of a vehicle rear and the lateral flow around the vehicle rear without the air-guiding element deployed,

FIG. 2 depicts another schematic perspective illustration of the vehicle rear as shown in FIG. 1 without the air-guiding element deployed,

FIG. 3 is a schematic perspective illustration of a vehicle rear and the lateral flow around the vehicle rear with a deployed surface element according to aspects of the invention of an air-guiding element,

FIG. 4 depicts another schematic perspective illustration of the vehicle rear as shown in FIG. 3 with the surface element of the air-guiding element deployed,

FIG. 5 depicts another schematic perspective view of the rear of a vehicle with the air guiding element extended,

FIG. 6 depicts a schematic perspective view of the air guiding element according to aspects of the invention with surface element and carrier element,

FIG. 7 depicts a schematic perspective view of the air guiding element according to aspects of the invention with surface element and carrier element in a retracted operating position,

FIG. 8 depicts a schematic perspective view of the air guiding element according to aspects of the invention with surface element and carrier element in an extended operating position,

FIG. 9 depicts a schematic perspective view of the air guiding element according to aspects of the invention with surface element, carrier element and drive element in an extended operating position, and

FIG. 10 depicts a further schematic perspective view of the air guiding element according to aspects of the invention as shown in FIG. 9, but without the surface element.

### DETAILED DESCRIPTION OF THE INVENTION

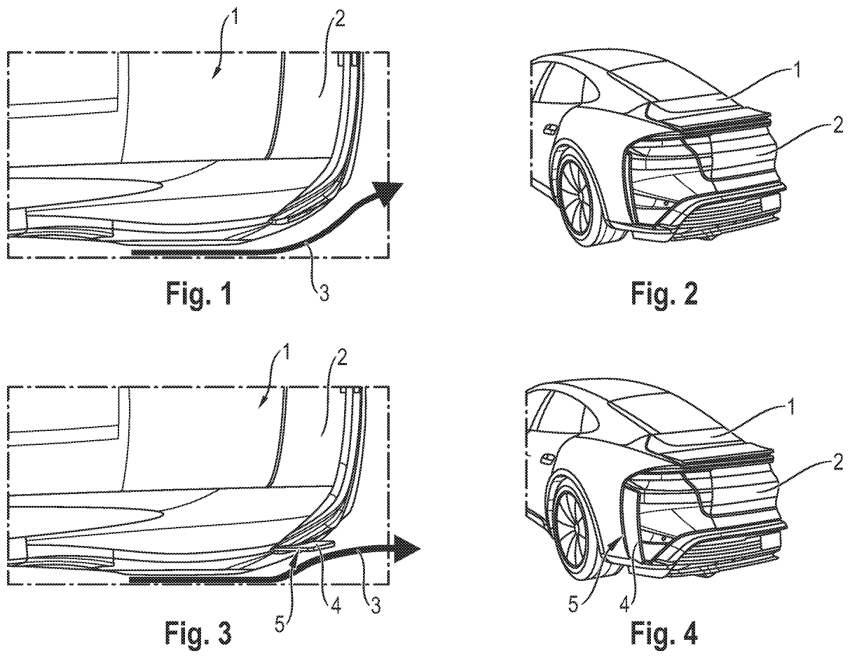

FIGS. 1 and 2 show a side of a vehicle rear 2 of a motor vehicle 1 without an air-guiding element, wherein the lateral flow around the vehicle rear 2 when traveling in the forward direction is indicated in FIG. 1 by the arrow 3. It can be seen that the air flowing laterally past the motor vehicle 1 flows inward behind the vehicle rear 2 and thus increases the air resistance.

FIGS. 3 and 4 show a side of a vehicle rear 2 of a motor vehicle 1 with a deployed surface element 4 of an air-guiding element 5, wherein the lateral flow around the vehicle rear 2 when traveling in forward direction is indicated in FIG. 3 by the arrow 3. It can be seen that the air flowing laterally past the motor vehicle 1 is deflected outward behind the vehicle rear 2 by the surface element 4 of the air-guiding element 5, so that the air does not flow as far inward as can be seen in FIG. 1 without the surface element of an air-guiding element, so that the air resistance for the operating state of FIG. 3 is lower than for the operating state as shown in FIG. 1.

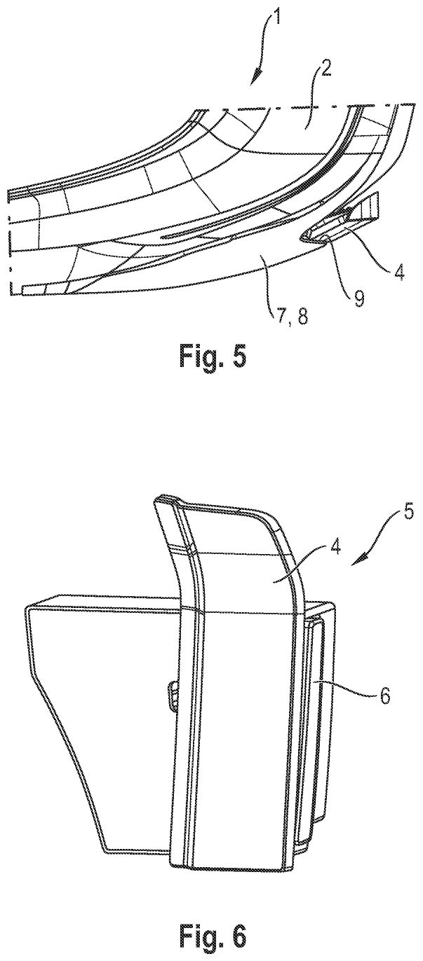

FIG. 5 shows the vehicle rear 2 of the motor vehicle 1 once again with the surface element 4 of the air guiding element 5 extended, wherein the surface element 4 can be seen as it is extended.

According to FIG. 6, the surface element 4 is displaceably guided on a carrier element 6, which is displaceable by a drive element. The surface element 4 is movably disposed in the vehicle rear 2 in a side part 7 or rear part 8, and can be guided out through a narrow opening 9 so that it is positioned in the air flow and can affect the flow around the vehicle rear 2.

FIGS. 6 to 10 show an example embodiment of an air-guiding element 5 according to aspects of the invention with a surface element 4 and a longitudinally displaceable carrier element 6.

The carrier element 6 can be displaced along a guide 11 by means of a drive element 10, wherein the drive element 10 can displace the carrier element 6 back and forth between two end positions.

The surface element 4 is hinged to the carrier element 6 in a movable manner, so that the surface element 4 is longitudinally displaceable with the carrier element 6 on the one hand, although further displacement of the surface element 4 relative to the carrier element 6 is still possible.

The drive element 10 has a gearwheel transmission 12, wherein the carrier element 6 can be driven in a longitudinally displaceable manner by means of the gearwheel transmission 12.

The drive element 10 is connected to a gearwheel 13 of the gearwheel transmission 12 so that it can be driven in rotation and the carrier element 6 comprises a rack 14 of the gearwheel transmission 12, which is connected to the carrier element 6. The gearwheel 13 meshes with the gear rack 14 and when the gearwheel 13 is turned, the gear rack 14 moves linearly, see FIG. 8.

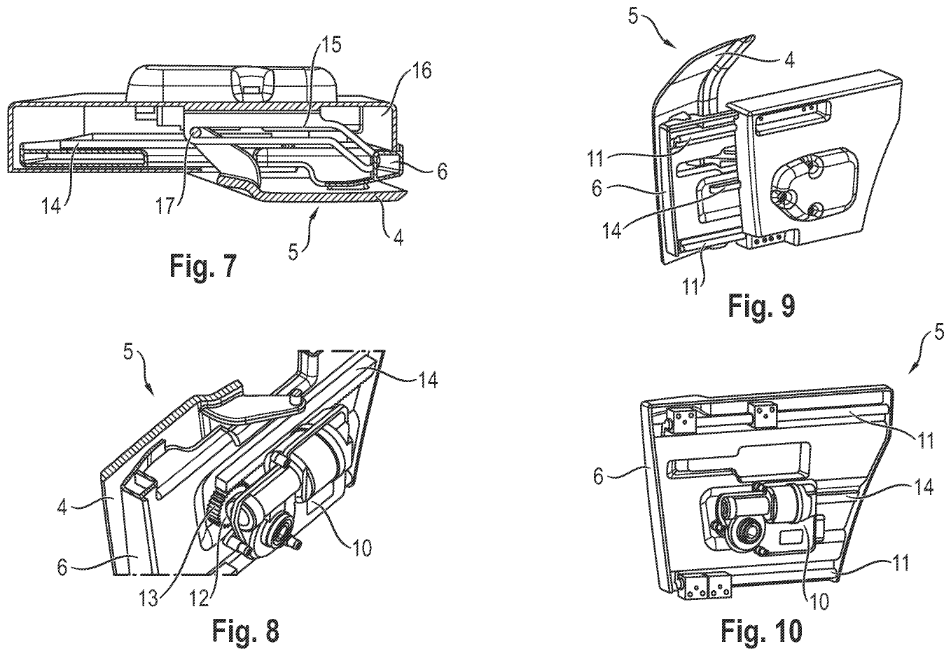

FIG. 7 shows that the surface element 4 is arranged in a retracted operating position and FIG. 9 shows that the surface element 4 is arranged in an extended operating position.

The carrier element 6 is mounted in a longitudinally displaceable manner in a side part 7 or rear part 8 of a motor vehicle 1, in particular a motor vehicle rear, wherein the surface element 4 is displaceably arranged through an opening 9 of the side part 7 or the rear part 8, see also FIG. 5. In the retracted operating position, the surface element 4 is disposed hidden in the side part 7 or rear part 8 as can be seen in FIGS. 1 and 2, and in the deployed state, the surface element 4 is deployed as can be seen in FIGS. 3 to 5.

It can also be seen in FIG. 7 that the surface element 4 is arranged on a sliding track 15 so that it can be displaced. The slide track 15 is arranged on the housing 16, wherein at least one sliding block 17 is arranged connected to the surface element 4, wherein the at least one sliding block 17 is arranged displaceably in the at least one slide track 15. Thus, in addition to the longitudinal displacement of the surface element 4 by means of the support element 6, a relative mobility of the surface element 4 to the support element 6 is also achieved. The path of movement of the surface element 4 relative to the carrier element 6 is determined by the geometry of the slide track 15.

The surface element 4 can be displaced or pivoted relative to the support element 6 and to the opening 9 when the at least one sliding block 17 is displaced in the sliding block path 15.

The motor vehicle 1 of FIGS. 1 to 5 shows only one surface element 4 on one side of the vehicle rear 2, wherein the air-guiding elements 5 are advantageously disposed in the rear region of the motor vehicle 1 on a side part 7 or rear part 8 on the two oppositely disposed sides of the motor vehicle 1. This applies to both example embodiments.

In the example embodiment it can also be seen that the at least one surface element 4 of the air-guiding element 5 is generally longitudinally displaceable along a straight, curved or arcuate path. In the figures of the two example embodiments, it can be seen that the path is arcuate. It can, however, also be straight or configured in some other way.

### LIST OF REFERENCE SIGNS

1 Motor vehicle
2 Vehicle rear
3 Arrow
4 Surface element
5 Air-guiding element
6 Carrier element
7 Side part
8 Rear part
9 Opening
10 Drive element
11 Guide
12 Gearwheel transmission
13 Gearwheel
14 Rack
15 Slide track
16 Housing
17 Sliding block

What is claimed is:

1. An air guiding element comprising:
a longitudinally displaceable carrier element;
a surface element articulated to the carrier element in a movably mounted manner; and
a drive element with a gearwheel transmission that is configured to drive the carrier element in a longitudinally displaceable manner,
wherein the gearwheel transmission comprises (i) a rack connected to the carrier element and (ii) a spur gear meshed with the rack.

2. The air-guiding element according to claim 1, wherein the carrier element is mounted in a longitudinally displaceable manner in a side part or a rear part of a motor vehicle.

3. The air-guiding element according to claim 2, wherein the surface element is configured to move through an opening of the side part or the rear part.

4. The air-guiding element according to claim 3, wherein the surface element is arranged to be displaceably guided relative to the carrier element by at least one slide track.

5. The air-guiding element according to claim 4, wherein at least one sliding block is connected to the surface element, wherein the at least one sliding block is arranged displaceably in the at least one slide track.

6. The air-guiding element according to claim 5, wherein the surface element is arranged to be displaceable or pivotable relative to the carrier element and/or to the opening when the at least one sliding block is displaced in the slide track.

7. The air-guiding element according to claim 1, wherein the surface element is arranged to be displaceably guided relative to the carrier element by at least one slide track.

8. The air-guiding element according to claim 7, wherein at least one sliding block is connected to the surface element, wherein the at least one sliding block is arranged displaceably in the at least one slide track.

9. A motor vehicle comprising a plurality of the air-guiding elements according to claim 1.

10. The motor vehicle according to claim 9, wherein the air-guiding elements are disposed in a rear region of the motor vehicle and on two oppositely disposed sides of the motor vehicle.

11. The motor vehicle according to claim 9, wherein at least one of the plurality of air-guiding elements is longitudinally displaceable along a straight, angled, curved or arcuate track.

12. The motor vehicle according to claim 9, wherein, for at least one of the plurality of air-guiding elements, the carrier element and the drive element with the gearwheel transmission are arranged in a side part or in a rear part of the motor vehicle, and the surface element is displaceable through an opening of the side part or of the rear part.
